(19) United States
(12) Patent Application Publication
(10) Pub. No.: US 2026/0229638 A1
(43) Pub. Date: Aug. 6, 2026

(54) TRACTION BATTERY PACK THERMAL BARRIER

(71) Applicant: Ford Global Technologies, LLC, Dearborn, MI (US)

(72) Inventors: Xiaogang Zhang, Novi, MI (US); James Alfred Hilditch, Canton, MI (US); Jianwen Yi, West Bloomfield, MI (US); Timothy R. Gernant, Ann Arbor, MI (US)

(21) Appl. No.: 19/042,359

(22) Filed: Jan. 31, 2025

(51) Int. Cl. H01M 10/6557; B60L 50/64; H01M 10/613; H01M 10/625; H01M 10/647; H01M 10/6555; H01M 10/6568; H01M 10/658; H01M 50/211

(52) U.S. Cl. CPC H01M 10/6557; H01M 10/613; H01M 10/625; H01M 10/647; H01M 10/6555; H01M 10/6568; H01M 10/658; H01M 50/211; B60L 50/64; H01M 2220/20

(57) ABSTRACT

A traction battery pack assembly includes a thermal barrier of a cell stack. The thermal barrier has a corrugated sheet sandwiched between a first flat sheet and a second flat sheet. The first flat sheet is a first material. The second flat sheet is a second material that is different than the first material.

### TECHNICAL FIELD

This disclosure details exemplary assemblies that guide liquid coolant within a battery pack and, more particularly, to a thermal barrier that is compressible and can guide the liquid coolant between cells of a cell stack.

### BACKGROUND

Electrified vehicles differ from conventional motor vehicles because electrified vehicles include a drivetrain having one or more electric machines. The electric machines can drive the electrified vehicles instead of, or in addition to, an internal combustion engine. A traction battery pack assembly can power the electric machines. As part of an immersion thermal management system, liquid coolant can be moved through the traction battery pack to help manage thermal energy within the traction battery pack.

### SUMMARY

In some aspects, the techniques described herein relate to a traction battery pack assembly, including: a thermal barrier of a cell stack, the thermal barrier having a corrugated sheet sandwiched between a first flat sheet and a second flat sheet, the first flat sheet a first material, the second flat sheet a second material that is different than the first material.

In some aspects, the techniques described herein relate to an assembly, wherein the first flat sheet and the corrugated sheet establish a plurality of first liquid coolant channels, and the second flat sheet and the corrugated sheet establish a plurality of second liquid coolant channels, the first and second liquid coolant channels each opening to a first side of the cell stack and to an opposite, second side of the cell stack.

In some aspects, the techniques described herein relate to an assembly, wherein the first and second liquid coolant channels each have a triangular cross-section.

In some aspects, the techniques described herein relate to an assembly, wherein the first side is an top side, and the second side is a bottom side.

In some aspects, the techniques described herein relate to an assembly, wherein the thermal barrier is disposed between axially adjacent battery cells within the cell stack.

In some aspects, the techniques described herein relate to an assembly, wherein the thermal barrier is compressible.

In some aspects, the techniques described herein relate to an assembly, wherein the corrugated sheet is attached to the first flat sheet and detached from the second flat sheet.

In some aspects, the techniques described herein relate to an assembly, wherein the first flat sheet is a metal or metal alloy, wherein the second flat sheet is a silicate material.

In some aspects, the techniques described herein relate to an assembly, wherein the first flat sheet is aluminum, wherein the second flat sheet is mica.

In some aspects, the techniques described herein relate to an assembly, wherein the corrugated sheet is a metal or metal alloy.

In some aspects, the techniques described herein relate to an assembly, wherein the corrugated sheet is welded to the first flat sheet.

In some aspects, the techniques described herein relate to an assembly, wherein the cell stack is within an interior of an enclosure, the cell stack including a plurality of battery cells disposed along a cell stack axis, the thermal barrier disposed between the plurality of battery cells along the cell stack axis.

In some aspects, the techniques described herein relate to an assembly, wherein the corrugated sheet is configured to flex to permit movement of the first flat sheet relative to the second flat sheet along the cell stack axis.

In some aspects, the techniques described herein relate to an assembly, further including a dielectric liquid coolant disposed within channels of the thermal barrier.

In some aspects, the techniques described herein relate to a traction battery pack assembly, including: at least one first battery cell of a cell stack; at least one second battery cell of the cell stack; and a thermal barrier of the cell stack, the thermal barrier disposed axially between the at least one first battery cell and the at least one second battery cell, the thermal barrier configured guide a liquid coolant through the cell stack between the at least one first battery cell and the at least one second battery cell, the thermal barrier including a corrugated sheet sandwiched between a first flat sheet and a second flat sheet, the corrugated sheet attached to the first flat sheet and detached from the second flat sheet.

In some aspects, the techniques described herein relate to a traction battery pack assembly, wherein the thermal barrier establishes at least one liquid coolant channel.

In some aspects, the techniques described herein relate to a traction battery pack assembly, wherein the corrugated sheet is welded to the first flat sheet.

In some aspects, the techniques described herein relate to a traction battery pack assembly, wherein the thermal barrier is compressible.

In some aspects, the techniques described herein relate to a traction battery pack assembly, wherein the at least one first battery cell and the at least one second battery cell are pouch-style.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a battery pack.

FIG. 2 illustrates a perspective, schematic view of the battery pack of FIG. 1.

FIG. 3 illustrates section view battery pack of FIG. 2 showing a portion of a cell stack disposed between an enclosure cover and an enclosure tray.

FIG. 4 illustrates a close of view of an area of FIG. 3 showing a portion of a thermal barrier of the cell stack and portions of battery cells of the cell stack.

FIG. 5 illustrates the close-up view of FIG. 4 after expansion of battery cells of the cell stack.

FIG. 6 illustrates a perspective view of the portion of the thermal barrier shown in FIG. 4.

FIG. 7 illustrates an expanded view of a portion of the thermal barrier of FIG. 6.

### DETAILED DESCRIPTION

An immersion thermal management system can be used to manage thermal energy in a traction battery pack. In such a traction battery pack, at least some components of the traction battery pack are immersed in a liquid coolant. The immersed components can include a cell stack.

This disclosure is directed toward guiding the liquid coolant through the cell stack using channels that are provided by a thermal barrier. During operation, cells may swell. The thermal barrier is somewhat compressible, which can facilitate accommodating the swelling.

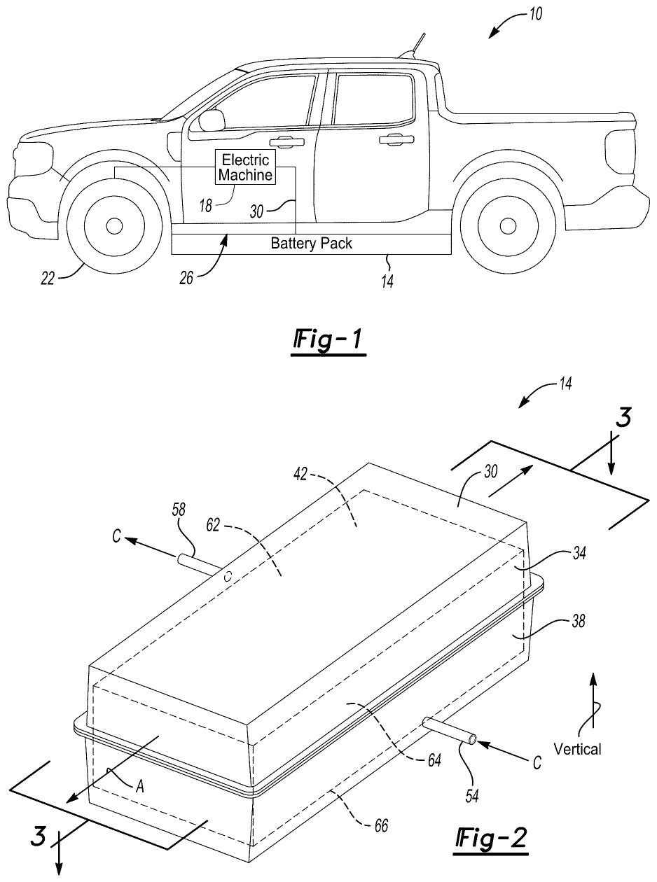

With reference to FIG. 1, an electrified vehicle 10 includes a traction battery pack 14, an electric machine 18, and wheels 22. The traction battery pack 14 powers an electric machine 18, which can convert electrical power to mechanical power to drive the wheels 22. The traction battery pack 14 can be a relatively high-voltage battery.

The traction battery pack 14 is, in the exemplary embodiment, secured to an underbody 26 of the electrified vehicle 10. The traction battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

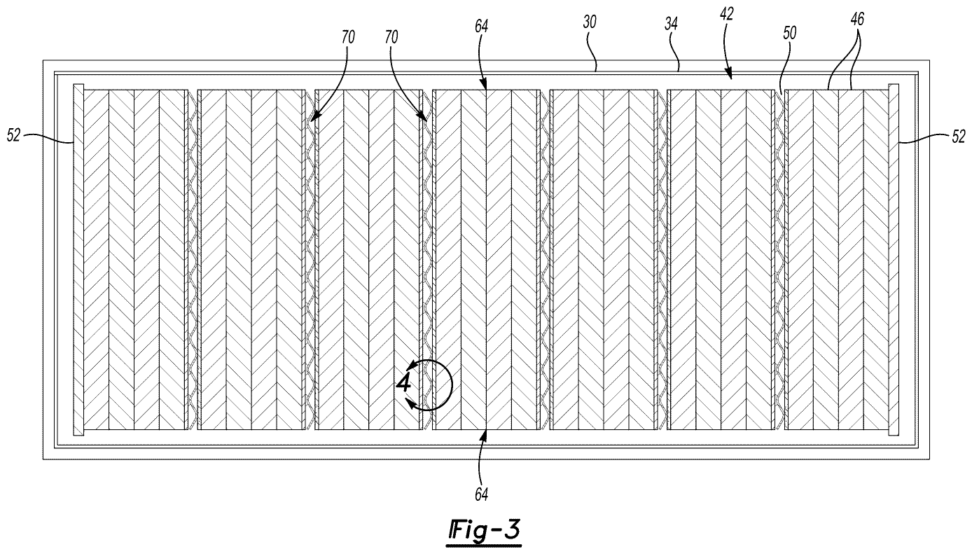

FIGS. 2 and 3 illustrates additional detail of the example battery pack 14. In this example, the battery pack 14 includes an enclosure assembly 30. The enclosure assembly 30 includes a cover 34 and a tray 38. The cover 34, in this example, is vertically above the tray 38. In other examples, however, the cover 34 could be arranged below, or to a side of the tray 38.

Various terms such as “vertical,” “above,” “below,” “top,” and “bottom” are used relative to the arrangement of the components of the battery pack 14 in the various drawings and should not otherwise be deemed limiting. These terms are with reference to the general orientation of the battery pack 14 when installed within the vehicle 10 of FIG. 1,

The cover 34 is welded to the tray 38 in one example of this disclosure. While welding is mentioned, the cover 34 and tray 38 could be connected using other fluid-tight connection techniques, such as adhesive. Further, while an exemplary enclosure assembly 30 is shown in the drawings, the enclosure assembly 30 may vary in size, shape, and configuration within the scope of this disclosure.

In this disclosure, a cell stack 42 is arranged within an interior of the enclosure assembly 30. The example cell stack 42 includes a plurality of individual battery cells 46 disposed along a cell stack axis A, and a plurality of thermal barriers 50. Each of the thermal barriers 50 can be sandwiched between two of the battery cells 46 along the cell stack axis. The battery cells 46 and thermal barriers 50 can be compressed along the cell stack axis A between a pair of endplates 52.

The cell stack 42 could include any number of battery cells 46. The battery pack 14 could employ any number of cell stacks 42 within the enclosure assembly 30. Thus, this disclosure is not limited to the exact configuration shown in FIG. 2. Further, while the battery cells 46 and thermal barriers 50 of FIG. 3 are positioned side-by-side relative to one another, other configurations are also contemplated within the scope of this disclosure, including but not limited to embodiments in which the battery cells 46 and thermal barriers 50 are stacked on top of one another, for example.

In an embodiment, the battery cells 46 are pouch-style, lithium-ion cells. However, battery cells having other geometries (cylindrical, prismatic, etc.), other chemistries (nickel-metal hydride, lead-acid, etc.), or both could alternatively be utilized within the scope of this disclosure.

The cell stack 42 is arranged in the interior of the enclosure assembly 30 between the tray 38 and the cover 34. A thermal management system is used to manage thermal energy levels within the battery pack 14. The example thermal management system is configured to route non-conductive (i.e., dielectric) coolant C over areas of the cell stack 42 to manage thermal energy within the cell stack 42 by, for example, using the coolant C to take on heat from the cell stack 42. The thermal management system is an immersion thermal management system at least because portions of the battery pack 14, here at least the battery cells 46 of the cell stack 42 are immersed in the coolant C.

The cell stack 42 has a top side 62, opposing outboard sides 64, and a bottom side 66. In this example, the coolant C generally flows from an inlet 54, which is formed near a vertical bottom of the enclosure assembly 30 on the first opposite side of the cell stack 42, to an outlet 58, which is adjacent a vertical top of the enclosure assembly 30 on an opposite, second side of the cell stack 42.

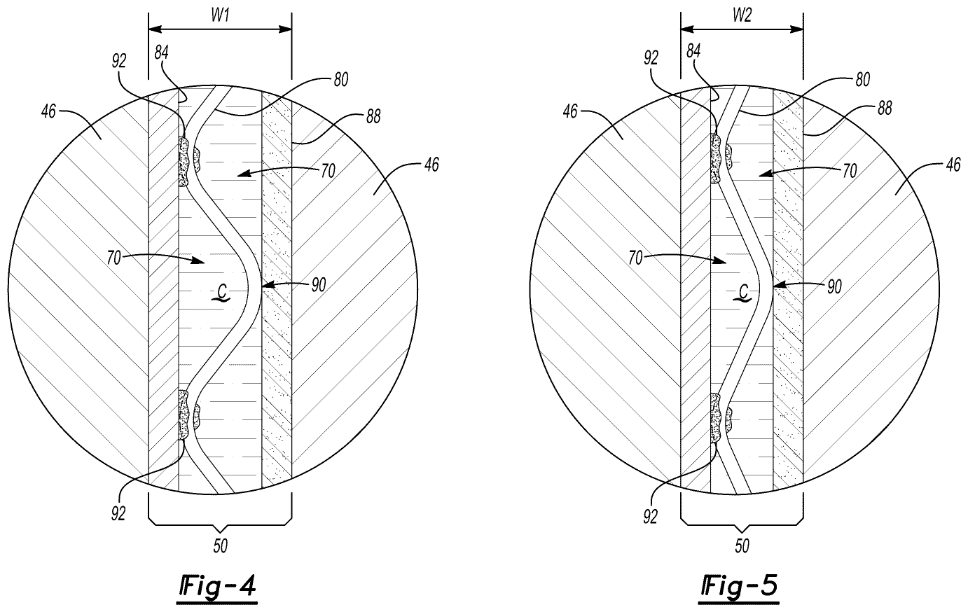

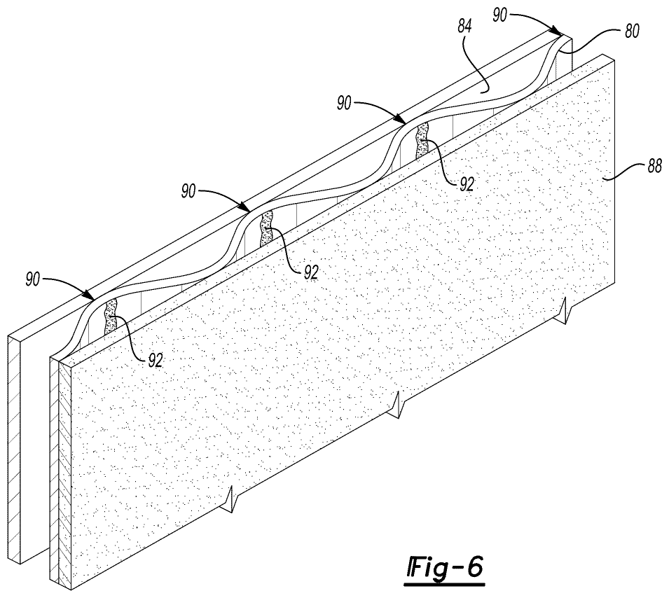

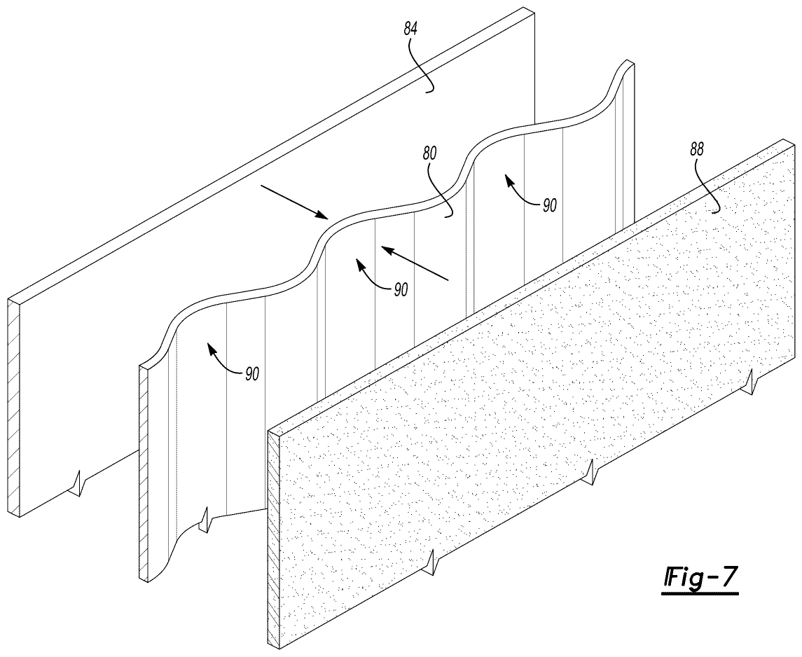

With reference now to FIGS. 4-7 and continuing reference to FIGS. 2 and 3, some of the coolant C communicates through the cell stack 42 in-between the battery cells 46 through at least one channel 70 established by the thermal barriers 50. Thermal energy can transfer between the coolant C and the battery cells 46 as the coolant C moves through the at least one channel 70 between the battery cells 46. The coolant C communicates vertically upward through the cell stack 42 in this example. The channels 70 each open to both the top side 62 and the bottom side 66 in this example.

The example thermal barriers 50 each include a corrugated sheet 80 sandwiched between a first flat sheet 84, and a second flat sheet 88. The corrugated sheet 80 includes a plurality of corrugations 90, which give the corrugated sheet 80 a wavy profile. The corrugated sheet 80, the first flat sheet 84, and the second flat sheet 88 can each be 0.5 millimeters thick to provide the thermal barrier 50 with an overall material thickness of about 1.5 millimeters. The overall barrier thickness will be larger and around 4 mm with a wave height of 2.5 mm.

The first flat sheet 84 and the corrugated sheet 80 establish some of the channels 70. The second flat sheet 88 and the corrugated sheet 80 establish some other channels 70. The channels 70 each have a substantially triangular cross-section in this example. Two sides of the triangle are provided by the corrugated sheet 80, and the remaining side is provided by the first flat sheet 84 or the second flat sheet 88.

In this example, the corrugated sheet 80 and the first flat sheet 84 are a metal or metal alloy, such as aluminum. The second flat sheet 88 is a different material from the first flat sheet 84. The second flat sheet 88 can be a silicate material, such as mica.

The first flat sheet 84 and the corrugated sheet 80 are attached to each other. The first flat sheet 84 and the corrugated sheet 80 can be attached via welds 92, for example. In contrast to the first flat sheet 84, the second flat sheet 88 is detached from the corrugated sheet 80.

The thermal barrier 50 is somewhat compressible. The corrugated sheet 80, and keeping the corrugated sheet 80 detached from the second flat sheet 88 can facilitate compression of the thermal barrier 50.

When initially installed, the cell stack 42 can be compressed between the endplates 52 such that a width of the thermal barrier 50 along the cell stack axis A is a width W1 shown in FIG. 4. Compressing the cell stack 42 can flex and flatten the corrugations 90 a bit. That is, a curvature of the corrugations 90 can change to accommodate expansion and retraction.

Over time, the cells 46 can expand along the cell stack axis A, which compresses the thermal barrier to have a width W2 shown in FIG. 5. If the cells 46 retract a bit from an expanded position, the corrugations 90 can flex to increase a width of the thermal barrier 50 and maintain contact with the adjacent battery cells 46.

Compressing the corrugations 90 flattens the corrugations 90. Keeping the corrugated sheet 80 detached from the second flat sheet 88 can facilitate expansion and retraction of the corrugated sheet 80 as the corrugated sheet 80 can flex and move relative to the second flat sheet 88. Flexing the corrugated sheet 80 permits movement of the first flat sheet 84 relative to the second flat sheet 88 along the cell stack axis A.

Features of disclosed examples include a thermal barrier that provides space for flow of a coolant between cells, and that guides flow moving between cells. The thermal barrier can be provided by a thermal barrier that can compress and expand to accommodate expansion and contract of the cells during operation. In the past, thermal barriers had incorporated foam to accommodate expansion. Exemplary embodiments of this disclosure may not require any foam or as much foam as such designs as expansion and retraction can be accommodated by the corrugated sheet. If a mica sheet is used, it can be much thinner than mica sheets used in the past.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A traction battery pack assembly, comprising:
a thermal barrier of a cell stack, the thermal barrier having a corrugated sheet sandwiched between a first flat sheet and a second flat sheet, the first flat sheet a first material, the second flat sheet a second material that is different than the first material.

2. The assembly of claim 1, wherein the first flat sheet and the corrugated sheet establish a plurality of first liquid coolant channels, and the second flat sheet and the corrugated sheet establish a plurality of second liquid coolant channels, the first and second liquid coolant channels each opening to a first side of the cell stack and to an opposite, second side of the cell stack.

3. The assembly of claim 2, wherein the first and second liquid coolant channels each have a triangular cross-section.

4. The assembly of claim 2, wherein the first side is an top side, and the second side is a bottom side.

5. The assembly of claim 1, wherein the thermal barrier is disposed between axially adjacent battery cells within the cell stack.

6. The assembly of claim 1, wherein the thermal barrier is compressible.

7. The assembly of claim 1, wherein the corrugated sheet is attached to the first flat sheet and detached from the second flat sheet.

8. The assembly of claim 1, wherein the first flat sheet is a metal or metal alloy, wherein the second flat sheet is a silicate material.

9. The assembly of claim 8, wherein the first flat sheet is aluminum, wherein the second flat sheet is mica.

10. The assembly of claim 9, wherein the corrugated sheet is a metal or metal alloy.

11. The assembly of claim 10, wherein the corrugated sheet is welded to the first flat sheet.

12. The assembly of claim 1, wherein the cell stack is within an interior of an enclosure, the cell stack including a plurality of battery cells disposed along a cell stack axis, the thermal barrier disposed between the plurality of battery cells along the cell stack axis.

13. The assembly of claim 12, wherein the corrugated sheet is configured to flex to permit movement of the first flat sheet relative to the second flat sheet along the cell stack axis.

14. The assembly of claim 1, further comprising a dielectric liquid coolant disposed within channels of the thermal barrier.

15. A traction battery pack assembly, comprising:
at least one first battery cell of a cell stack;
at least one second battery cell of the cell stack; and
a thermal barrier of the cell stack, the thermal barrier disposed axially between the at least one first battery cell and the at least one second battery cell, the thermal barrier configured guide a liquid coolant through the cell stack between the at least one first battery cell and the at least one second battery cell, the thermal barrier including a corrugated sheet sandwiched between a first flat sheet and a second flat sheet, the corrugated sheet attached to the first flat sheet and detached from the second flat sheet.

16. The traction battery pack assembly of claim 15, wherein the thermal barrier establishes at least one liquid coolant channel.

17. The traction battery pack assembly of claim 15, wherein the corrugated sheet is welded to the first flat sheet.

18. The traction battery pack assembly of claim 15, wherein the thermal barrier is compressible.

19. The traction battery pack assembly of claim 15, wherein the at least one first battery cell and the at least one second battery cell are pouch-style.
